(19) United States
(12) Patent Application Publication
(10) Pub. No.: US 2026/0138538 A1
(43) Pub. Date: May 21, 2026

(54) VEHICULAR STORAGE STRUCTURE

(71) Applicants: TOYOTA BOSHOKU KABUSHIKI KAISHA, Aichi-ken (JP); TOYOTA JIDOSHA KABUSHIKI KAISHA, Aichi-ken (JP)

(72) Inventors: Mitsuhiko TAKESHIGE, Nagakute-shi (JP); Isao SHINAGAWA, Toyota-shi (JP)

(73) Assignees: TOYOTA BOSHOKU KABUSHIKI KAISHA, Aichi-ken (JP); TOYOTA JIDOSHA KABUSHIKI KAISHA, Aichi-ken (JP)

(21) Appl. No.: 19/391,511

(22) Filed: Nov. 17, 2025

(30) Foreign Application Priority Data
Nov. 20, 2024 (JP) 2024-202020

(51) Int. Cl. B60R 7/04; B60R 7/08

(52) U.S. Cl. CPC B60R 7/04; B60R 7/08

(57) ABSTRACT

A vehicular storage structure includes a storage body member that stores an item and is accessible through an opening of a vehicular interior component from a vehicular interior side and disposed on a vehicular exterior side of the opening, and a belt member having an elongated shape and elasticity and being configured to hold the item stored in the storage body member with respect to the storage body member. The belt member is fixed to a vehicular body together with the storage body member.

### CROSS REFERENCE TO RELATED APPLICATION

This application claims priority from Japanese Patent Application No. 2024-202020 filed on Nov. 20, 2024. The entire contents of the priority application are incorporated herein by reference.

### TECHNICAL FIELD

The present technology described herein relates to a vehicular storage structure.

### BACKGROUND

There has been known a storage recessed portion on a vehicular interior side wall of a vehicle. For instance, a side wall member that faces a rear space behind a rear seat includes a storage box that is recessed and opens toward a vehicular interior side. The storage box includes a first belt and a second belt that extend from a bottom wall thereof. The first belt and the second belt are configured as one continuous belt. Two ends of the continuous belt are inserted through two through holes in a rear wall of the storage box to the inside of the storage box. A boss, which is a stopper, projects from the wall of the storage box. A connection portion of the continuous belt that connects the first belt and the second belt is on a rear surface side of the rear wall and is fixed to the boss with thermal riveting via a washer.

The first belt and the second belt are wound around an item stored in such a storage box and are connected to each other by a holder such that the item is held in the storage box.

### SUMMARY

However, in such a structure, if a large load is applied to the storage box in a direction that the stored item is to be taken from due to shock caused by sudden acceleration or collision of a vehicle, the continuous belt may be pulled in the direction due to the weight of the stored item. As a result, the storage box may be deformed or the connection portion of the continuous belt may be damaged or torn and the stored item may drop from the storage box.

An object of the present technology described herein is to provide a vehicular storage structure including a storage portion accessible from a vehicular interior side and storing an item and from which the item is less likely to drop due to sudden acceleration and collision of a vehicle.

A vehicular storage structure according to the technology described herein includes a storage body member that stores an item and is accessible through an opening of a vehicular interior component from a vehicular interior side and disposed on a vehicular exterior side of the opening, and a belt member having an elongated shape and elasticity and being configured to hold the item stored in the storage body member with respect to the storage body member. The belt member is fixed to a vehicular body together with the storage body member.

### BRIEF DESCRIPTION OF THE DRAWINGS

FIG. 1 is a perspective view of a luggage compartment that including a vehicular storage structure according to one embodiment seen from a vehicular front left side.

FIG. 2 is a perspective view of the luggage compartment with a cover member being detached seen from the vehicular front left side.

FIG. 3 is an elevation view of a storage portion on a right side with the cover member being detached.

FIG. 4 is a lateral cross-sectional view of the storage portion that stores a bottle shaped item.

FIG. 5 is a vertical cross-sectional view of the storage portion that stores the bottle shaped item.

FIG. 6 is a perspective view of a storage body member on a right side.

FIG. 7 is a perspective view of the storage body member to which the bottle shaped item is fixed.

FIG. 8 is an exploded side view of a portion of the storage portion.

FIG. 9 is a lateral cross-sectional view of a storage portion on a left side that stores a box shaped item.

FIG. 10 is a perspective view of a storage body member on a left side.

### DETAILED DESCRIPTION

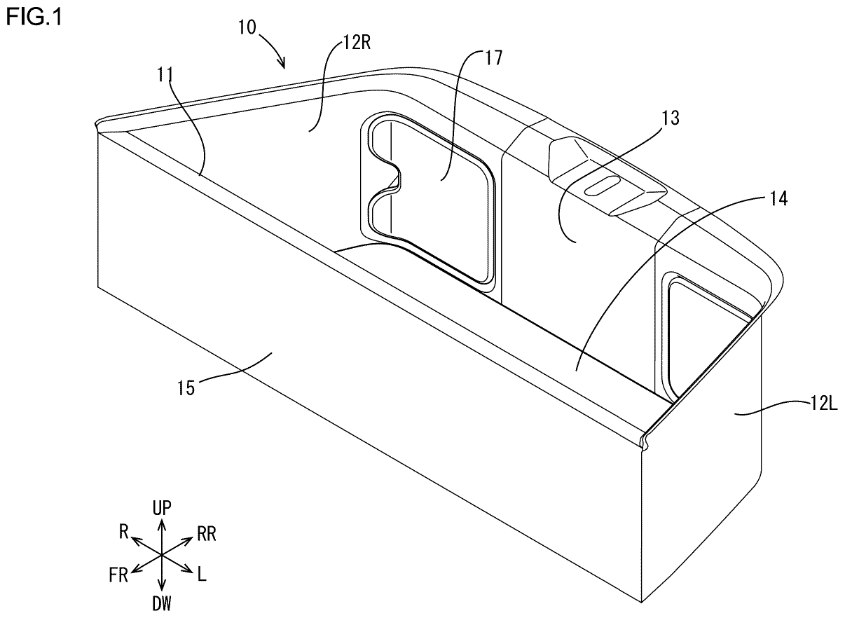

A vehicular storage structure 1 according to one embodiment will be described with reference to FIGS. 1 to 10. In the drawings, arrows of FR and RR represent a vehicular front side and a vehicular rear side, arrows of UP and DW represent an upper side and a lower side, and arrows of R and L represent a right side and a left side in a forwarding direction of a vehicle. A reference sign is applied to one of the same components and the reference signs may not be applied to other components.

FIG. 1 is a perspective view of a luggage compartment 10 that is in a rear section of a vehicle and seen from a vehicular front left side. The luggage compartment 10 is accessible through a vehicular rear section opening 11 with a rear door being open.

The luggage compartment 10 includes deck side trims 12R, 12L, a finisher 13, a deck board 14, and a luggage front trim 15. The luggage compartment 10 has a space surrounded by the deck side trims 12R, 12L, the finisher 13, the deck board 14, and the luggage front trim 15. The deck side trims 12R, 12L are configured as right and left side surfaces and portions of a rear surface of the luggage compartment 10. The finisher 13 is a plate member disposed at a rear end of the luggage compartment 10. The finisher 13 is disposed between the deck side trims 12R, 12L and configured as a middle portion of the rear surface. The deck board 14 is configured as a floor surface and the luggage front trim 15 is configured as a front surface in the luggage compartment 10.

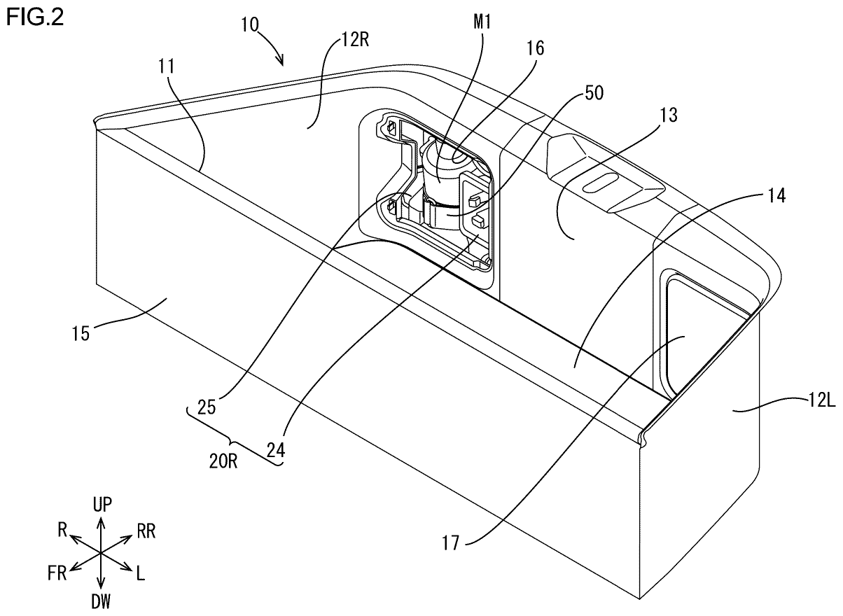

As illustrated in FIG. 2, the deck side trims 12R, 12L include storage portions 20R, 20L, respectively, on portions thereof configured as the rear surface of the luggage compartment 10. The storage portion 20R of the deck side trim 12R on the right side will be described.

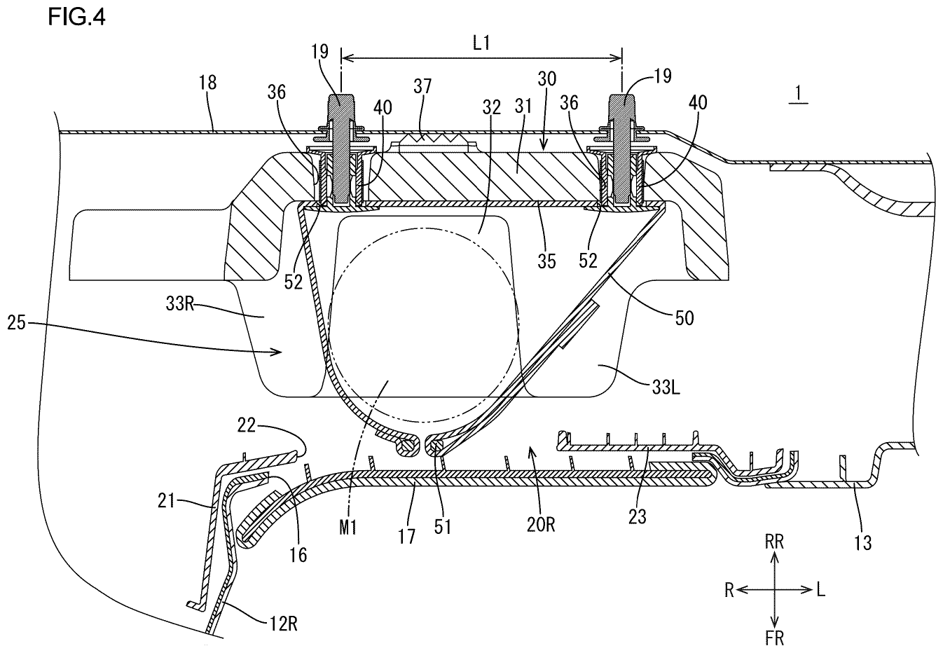

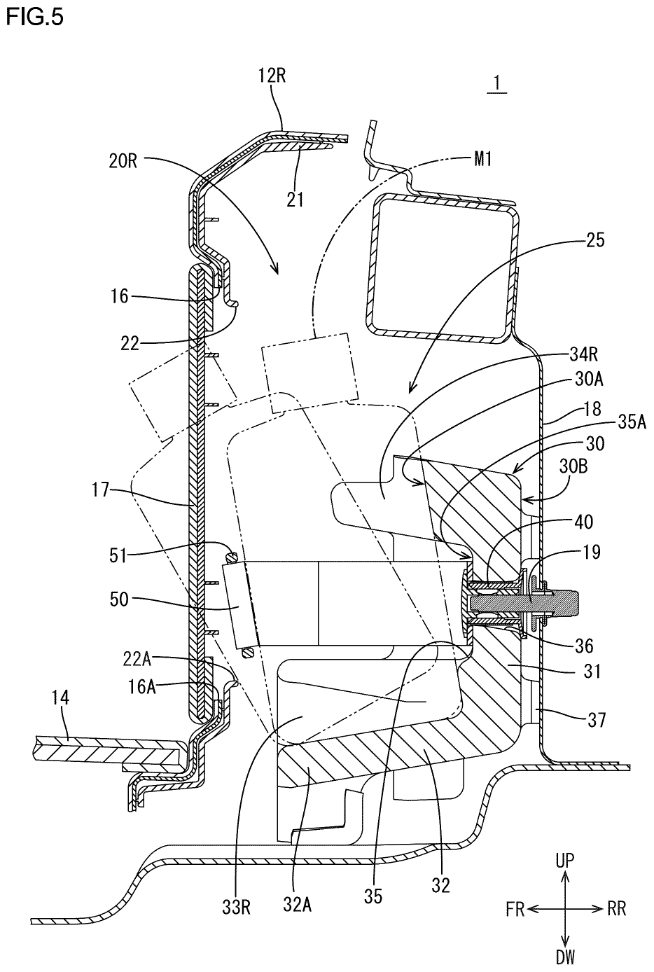

As illustrated in FIG. 2, the deck side trim 12R has a trim side opening 16 (one example of an opening) in a rear portion thereof. The storage portion 20R is accessible through the trim side opening 16 from a vehicular interior side (from the luggage compartment 10). A specific item M1 such as a repair kit installed in a vehicle is stored in the storage portion 20R. As illustrated in FIG. 1, the trim side opening 16 can be covered by a cover member 17 from the vehicular interior side. As illustrated in FIGS. 4 and 5, the storage portion 20R includes a frame portion 21 and a storage body member 30 that are not portions of the deck side trim 12R and are on a vehicular exterior side of the trim side opening 16.

The frame portion 21 has a frame shape and is disposed to reinforce the portion of the deck side trim 12R around the trim side opening 16 from the vehicular exterior side (a vehicular rear side). The frame portion 21 has a frame side opening 22 in a portion thereof corresponding to the trim side opening 16. The trim side opening 16 and the frame side opening 22 overlap and are communicated with each other. The frame side opening 22 is smaller than the trim side opening 16. Accordingly, an opening edge of the frame side opening 22 is disposed inside the trim side opening 16. Namely, the opening edge of the frame side opening 22 projects inward from an opening edge of the trim side opening 16.

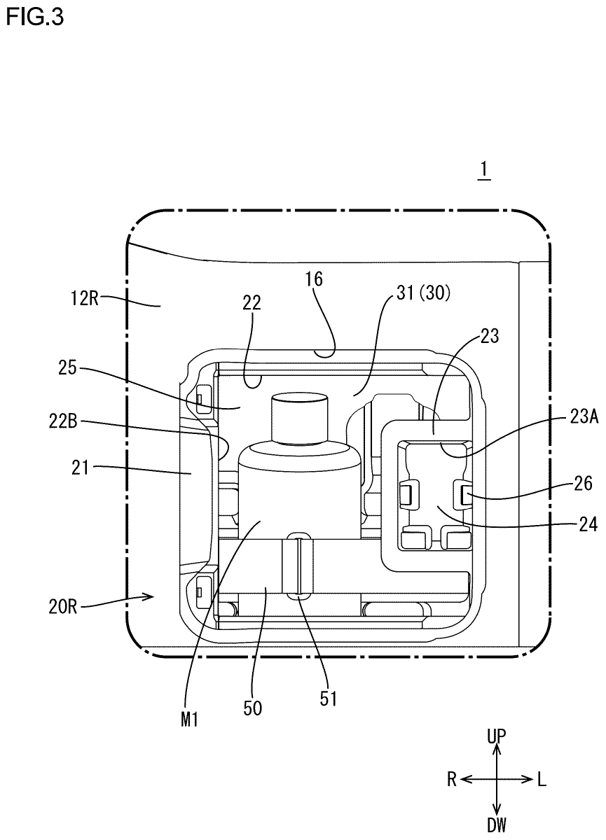

As illustrated in FIG. 3, a portion of the opening edge of the frame side opening 22 projects toward the inside of the trim side opening 16 much further than other portions of the opening edge of the frame side opening 22 and is defined as an extending portion 23. The extending portion 23 has a square shape and a first opening 23A that is through in a vehicular interior-exterior direction. The storage portion 20R is divided into a first storage portion 24 and a second storage portion 25 and the frame side opening 22 is divided into the first opening 23A of the extending portion 23 and a second opening 22B The first storage portion 24 is accessible through the first opening 23A and the second storage portion 25 is accessible through the second opening 22B The extending portion 23 (the first storage portion 24) includes projections 26 that project inward to the first opening 23A and hold a tubular item stored in the first storage portion 24.

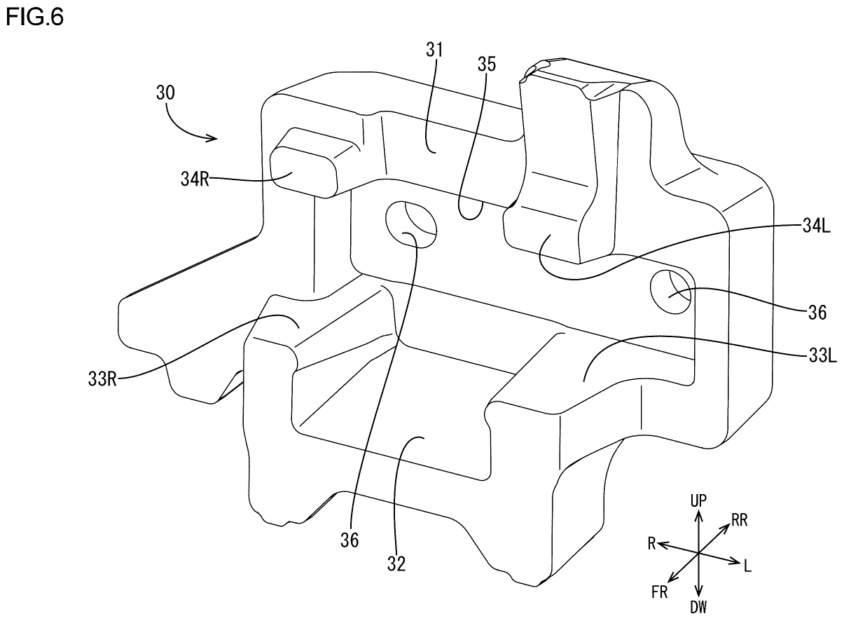

As illustrated in FIGS. 4 and 5, the storage body member 30 is disposed on the vehicular exterior side (the vehicular rear side) of the frame portion 21. Specifically, as illustrated in FIG. 6, the storage body member 30 includes a rear wall portion 31, a bottom wall portion 32, a right side wall portion 33R, a left side wall portion 33L, a right support wall portion 34R, and a left support wall portion 34L. The rear wall portion 31 is on the rear side seen from the trim side opening 16 of the rear surface portion of the deck side trim 12R. The rear wall portion 31 is opposite the inner panel 18 and extends along the inner panel 18. The bottom wall portion 32 (a receiving surface) extends toward the vehicular interior side from a lower edge of the rear wall portion 31. The right side wall portion 33R and the left side wall portion 33L extend upward from two edges of the bottom wall portion 32 with respect to the vehicular width direction. The right support wall portion 34R and the left support wall portion 34L extend toward the vehicular interior side from the rear wall portion 31. The right support wall portion 34R and the left support wall portion 34L are above the right side wall portion 33R and the left side wall portion 33L.

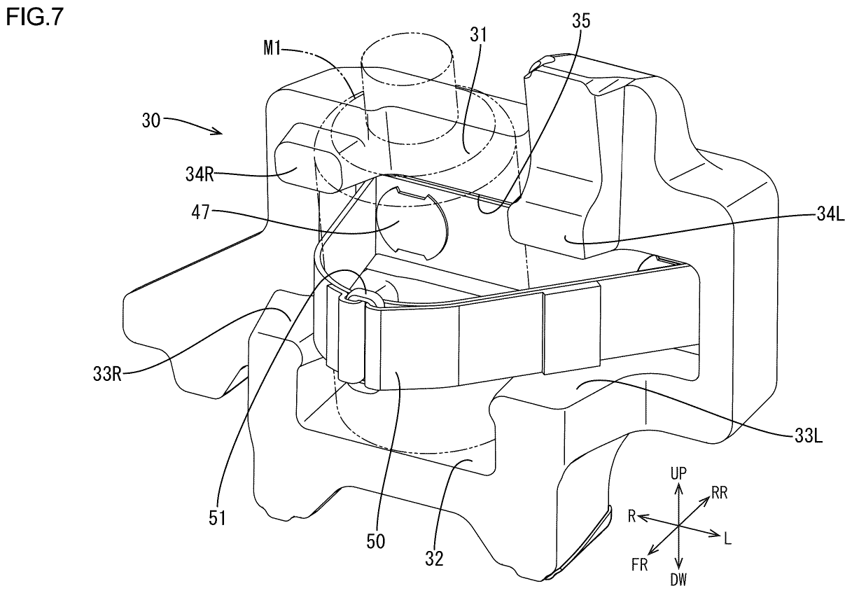

The storage body member 30 includes the second storage portion 25 for storing an item M1 having a specific bottle shape such as a bottle filled with puncture repair agent which is a puncture repair kit. As illustrated in FIG. 7, with the item M1 being disposed on the bottom wall portion 32 (the receiving surface) of the storage body member 30, a lower portion of the item M1 is supported by the right side wall portion 33R and the left side wall portion 33L from the lateral side (the right and left sides) and an upper portion of the item M1 is supported by the right support wall portion 34R and the left support wall portion 34L from the lateral side (the right and left sides). Accordingly, the item M1 that is disposed on the bottom wall portion 32 can keep a stable posture with respect to the vehicular width direction.

The storage body member 30 is a molded body made of expanded beads of olefine resin such as polypropylene. The storage body member 30 has a low density compared to the deck side trims 12R, 12L and the frame portion 21 and has elasticity.

As illustrated in FIGS. 4 and 5, the storage body member 30 is disposed on the vehicular exterior side (the vehicular rear side) of the trim side opening 16 such that the bottom wall portion 32, the right side wall portion 33R, the left side wall portion 33L, the right support wall portion 34R, and the left support wall portion 34L project toward the trim side opening 16. The storage body member 30 is fixed to an inner panel 18 (one example of a vehicular body) of a vehicular body that is disposed on the vehicular exterior side of the storage body member 30. Specifically, as illustrated in FIGS. 4 to 6, the rear wall portion 31 of the storage body member 30 includes a recessed portion 35 on a vehicular interior side surface 30A of the rear wall portion 31. The recessed portion 35 is recessed toward the vehicular exterior side and the recessed portion 35 is a shallow recess. The recessed portion 35 includes two through holes 36 (first through holes) that are through the thickness of a recessed surface 35A of the recessed portion 35. The two through holes 36 are arranged in the right-left direction. Gromets 40 are fitted in the through hole 36, respectively. Stud bolts 19 that are fixed to the inner panel 18 are fitted in the gromets 40, respectively, and thus, as illustrated in FIGS. 4 and 5, the storage body member 30 is fixed to the inner panel 18 (the vehicular body). The gromet 40 and the stud bolt 19 are configured as a fixing member.

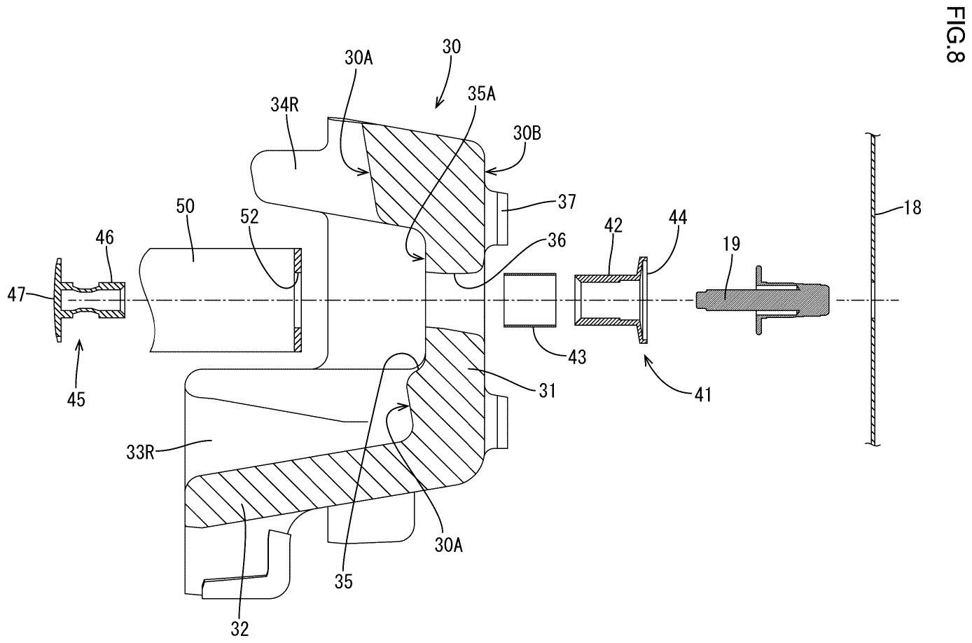

As illustrated in FIG. 8, the gromet 40 includes a first member 41 and a second member 45 and is configured by joining the first member 41 and the second member 45. The first member 41 includes an outer tubular portion 42, a non-woven fiber 43, and a first flange portion 44. The outer tubular portion 42 has a tubular shape and has an outer diameter that can be fitted in the through hole 36. The non-woven fiber 43 is wound around the outer tubular portion 42. The first flange portion 44 projects outwardly from a vehicular exterior side end portion of the outer tubular portion 42 in a radial direction of the outer tubular portion 42 and extends along a hole edge portion of the through hole 36. The second member 45 includes an inner tubular portion 46 and a second flange portion 47. The inner tubular portion 46 is fitted in the outer tubular portion 42. The second flange portion 47 projects outwardly from a vehicular interior side end portion of the inner tubular portion 46 in a radial direction of the inner tubular portion 46. The second flange portion 47 extends along a hole edge portion of a band side through hole 52 of a fastener band 50. The inner diameter of the inner tubular portion 46 is determined such that the stud bolt 19, which is fixed to the inner panel 18, can be fitted in the inner tubular portion 46.

As illustrated in FIG. 4, a middle portion of the fastener band 50 with respect to the elongated direction is disposed in the recessed portion 35 of the rear wall portion 31 of the storage body member 30. The middle portion of the fastener band 50 includes the band side through holes 52 (second through holes) in portions corresponding to the two through holes 36 of the recessed portion 35 of the rear wall portion 31, respectively. With such a configuration, the fastener band 50 is disposed in the recessed portion 35 and fixed to the storage body member 30 and the inner panel 18 easily.

As illustrated in FIG. 8, after the first member 41 of the gromet 40 is inserted in the through hole 36 from the vehicular exterior side, the inner tubular portion 46 of the second member 45 is inserted through the band side through hole 52 and fitted in the outer tubular portion 42, which is fitted in the through hole 36, from the vehicular interior side. Thus, the first member 41 and the second member 45 are fitted together and the gromet 40 is fixed to the rear wall portion 31 of the storage body member 30. The storage body member 30 and the fastener band 50 are fixed together with the gromet 40. Then, with the stud bolt 19 that projects from the inner panel 18 being fitted in the gromet 40 from the vehicular exterior side, the storage body member 30 is fixed to the inner panel 18. Thus, the fastener band 50 is fixed to the inner panel 18 together with the storage body member 30.

With the storage body member 30, to which the fastener band 50 is fixed, being fixed to the inner panel 18 in a correct posture, as illustrated in FIG. 5, the bottom wall portion 32 slopes down as it extends toward the vehicular interior side (the vehicular front side). Accordingly, the vehicular interior side surface 30A of the rear wall portion 31, which faces the trim side opening 16, extends from the bottom wall portion 32 substantially vertically and further extends with being inclined toward the vehicular interior side as it extends upward. The vehicular interior side surface 30A slopes to be farther away from the vehicular exterior side surface 30B as it extends upward. As illustrated in FIG. 5, the vehicular exterior side surface 30B of the rear wall portion 31 and the recessed surface 35A of the recessed portion 35 extend vertically and parallel to each other. With the storage body member 30 being fixed to the inner panel 18 in the correct posture, the bottom wall portion 32 is disposed lower than a lower hole edge 16A of the trim side opening 16 and a lower hole edge 22A of the frame side opening 22.

As illustrated in FIGS. 5 and 8, the rear wall portion 31 of the storage body member 30 includes surface contact portions 37 (projections). The surface contact portions 37 project from the vehicular exterior side surface 30B of the rear wall portion 31. With the storage body member 30 being fixed to the inner panel 18, an appropriate space is created by the surface contact portions 37 between the rear wall portion 31 and the inner panel 18 necessary for fixing the rear wall portion 31 to the inner panel 18.

In this embodiment, as illustrated in FIGS. 3 to 5 and 7, the fastener band 50 (one example of a belt member) is mounted on the storage body member 30. The fastener band 50 is tightened with respect to the storage body member 30 to hold the item M1 stored in the storage body member 30. The fastener band 50 is an elongated belt member having elasticity. The fastener band 50 is a hook and loop fastener that includes a hook portion on at least one surface of one end portion thereof and a loop portion on the one surface of a portion other than the hook portion. The hook portion and the loop portion can be attached. A square ring 51 (one example of a ring) for folding the fastener band is attached to other end of the fastener band 50 (an end portion opposite from the hook portion). After the fastener band 50 being wound around the item M1, the one end portion (the end portion opposite from the square ring 51) of the fastener band 50 is inserted through the square ring 51 and folded back and the hook portion and the loop portion are attached together with an appropriate length. Thus, the item M1 is held tightly and fixed.

To store the item M1 of a specific bottle shape in the storage portion 20R of this embodiment, the cover member 17, which covers the trim side opening 16 of the storage portion 20R, is detached and the item M1 is put in the second storage portion 25 and disposed on the bottom wall portion 32 of the storage body member 30. Then, the fastener band 50 extending from the rear wall portion 31 is wound around the item M1 and the other end of the fastener band 50 (the end opposite from the square ring 51) is inserted through the square ring 51 that is attached to the one end of the fastener band 50 and folded back and pulled. Accordingly, the fastener band 50 is fastened and the item M1 is held with a large force. Thereafter, the hook portion and the loop portion of the fastener band 50 are attached to each other with an appropriate length and thus, the item M1 is fixed to the storage body member 30. Afte the item of a specific tubular shape is stored in the first storage portion 24, the cover member 17 is attached to close the storage portion 20R.

With a vehicle receiving shock caused by sudden acceleration or collision, a large load is applied to the item M1 stored in the storage portion 20R in a direction that the item M1 is to be taken from and a large load is also applied to the fastener band 50. In this embodiment, the fastener band 50 is fixed to the inner panel 18 (the vehicular body) together with the storage body member 30 and the inner panel 18 (the vehicular body) has relatively great strength. Therefore, the storage body member 30 is less likely to be deformed and the fixing portions of the fastener band 50 are less likely to be torn or damaged compared to a configuration in which a fastener band is only fixed to a storage body member that is a molded body made of expanded beads and has relatively small strength. Namely, the item M1 is less likely to drop from the storage portion 20R due to shock caused by sudden acceleration or collision of a vehicle.

On the other hand, to take the item M1 from the storage portion 20R, the cover member 17 that covers the storage portion 20R is detached and the fastening of the fastener band 50 is released to loosen the fastener band 50 and the tight holding of the item M1 is released. Since the bottom wall portion 32 of the storage body member 30 is inclined toward the vehicular front side as it extends downward, with the loosening of the fastener band 50, the item M1 disposed on the bottom wall portion 32 slides toward the vehicular interior side or moves to be inclined frontward as illustrated in FIG. 5 due to its own weight. Therefore, the item M1 can be taken from the storage portion 20R easily without inserting a hand into the storage portion 20R. As illustrated in FIG. 5, the vehicular interior side end portion 32A (a front end portion) of the bottom wall portion 32 of the storage body member 30 is disposed lower than the lower hole edge 16A of the trim side opening 16 and the lower hole edge 22A of the frame side opening 22. Furthermore, friction is caused between the bottom wall portion 32 of the storage body member 30 and the item M1 when the item M1 moves. Therefore, the item M1 is less likely to unintentionally drop from the storage portion 20R into the luggage compartment 10.

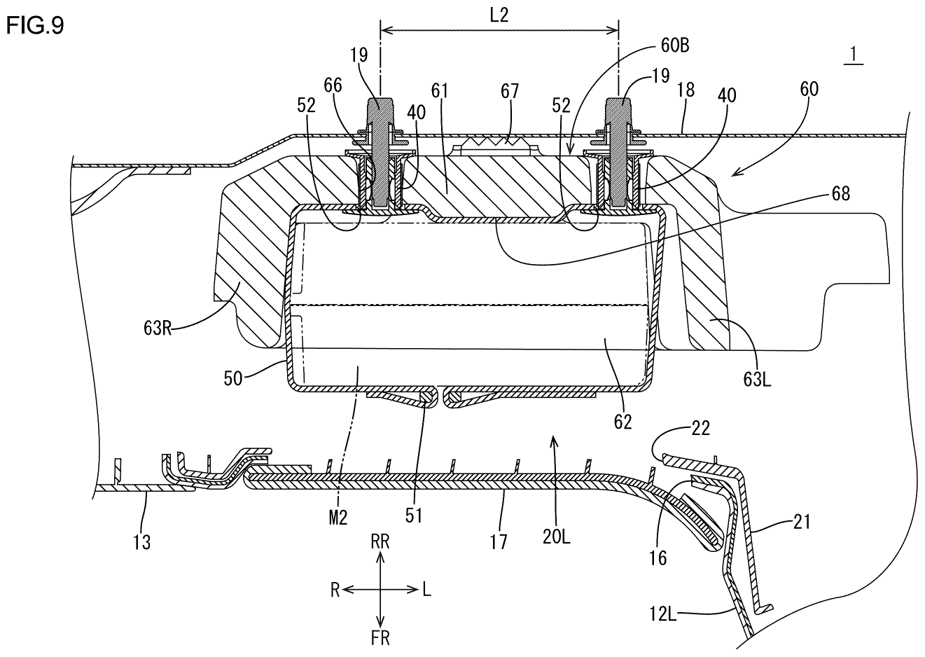

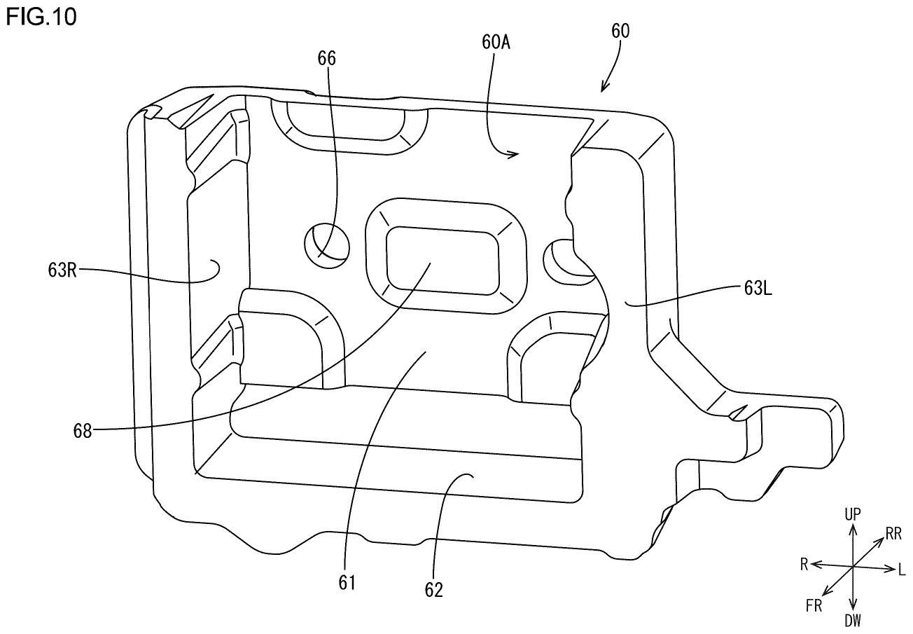

The storage portion 20R of the deck side trim 12R on the right side is described and the storage portion 20L of the deck side trim 12L on the left side will be described with reference to FIGS. 9 and 10. The configuration of the storage portion 20L that differs from that of the storage portion 20R will be described and the configuration same as that of the storage portion 20R will not be described. The same components as those of the storage portion 20R are applied with the same reference signs.

The storage portion 20R on the right side is configured to store the item M1 having a tubular shape. The storage portion 20L on the left side is configured to store an item M2 having a rectangular box shape such as a compressor. The storage portion 20L includes a storage body member 60. The storage body member 60 includes wall portions that support the item M2 from the lateral sides and the lower side. Specifically, as illustrated in FIG. 10, the storage body member 60 includes a rear wall portion 61, a bottom wall portion 62, a right side wall portion 63R, and a left side wall portion 63L. The rear wall portion 61 is on the rear side seen from the trim side opening 16. The bottom wall portion 62 extends toward the vehicular interior side from a lower edge of the rear wall portion 61. The right side wall portion 63R and the left side wall portion 63L extend upward from two edges of the bottom wall portion 62 with respect to the vehicular width direction. The rear wall portion 61 of the storage body member 60 includes a surface contact portion 67. The surface contact portion 67 projects from a vehicular exterior side surface 60B of the rear wall portion 61. The storage body member 60 is configured to store the item M2 having a specific box shape.

The rear wall portion 61 of the storage body member 60 includes two through holes 66 and a projection portion 68 between the two through holes 66. The projection portion 68 projects from a vehicular interior side surface 60A of the rear wall portion 61 toward the vehicular interior side (the vehicular front side). The projection portion 68 has a flat rectangular projection. A distance L2 between the two through holes 66 is shorter than a distance L1 between the two through holes 36 of the storage body member 30 (L2<L1). As illustrated in FIG. 9, with the portion of the fastener band 50 between the two through holes 66 extending along the projection portion 68, which projects from the vehicular interior side surface 60A toward the vehicular interior side, the difference between the dimensions of L1 and L2 is absorbed. Therefore, the fastener band 50 can be commonly used for the storage portion 20R on the right side and the storage portion 20L on the left side.

Operations and effects of the vehicular storage structure 1 of this embodiment will be described. The vehicular storage structure 1 of this embodiment includes the storage body member 30 and the fastener band 50. The storage body member 30 stores the item M1 and is disposed on the vehicular exterior side of the trim side opening 16 of the deck side trim 12R and is accessible from the vehicular interior side through the trim side opening 16. The fastener band 50 has an elongated shape and is configured to hold the item M1 that is stored in the storage body member 30 with respect to the storage body member 30. The fastener band 50 is fixed to the inner panel 18 of the vehicle together with the storage body member 30.

With the above configuration, the fastener band 50 that holds the item M1 with respect to the storage body member 30 is fixed to the inner panel 18, which has relatively great strength, together with the storage body member 30. Therefore, if a vehicle receives shock caused by sudden acceleration or collision and a large load is applied to the storage body member 30 in a direction that the item M1 is to be taken from the storage body member 30, the storage body member 30 is less likely to be deformed and the fixing portions of the fastener band 50 are less likely to be torn or damaged compared to a configuration in which a fastener band is fixed only to a storage body member having relatively small strength. Therefore, the item M1 is less likely to drop from the storage body member 30. Furthermore, the storage body member 30 and the fastener band 50 can be fixed to the inner panel 18 at the same time and this improves mounting workability.

The storage body member 30 is a molded body made of expanded beads. With such a configuration, the weight of the storage body member 30 can be reduced. With the item M1 being stored in the storage body member 30 that is elastic and relatively soft, the item M1 can be held in a good condition and the item M1 is less likely to drop from the storage body member 30 due to shock caused by sudden acceleration or collision of a vehicle.

The upper surface of the bottom wall portion 32 where the item M1 is disposed is inclined downward as it extends toward the vehicular interior side. With such a configuration, when the fastener band 50 is loosened and the item M1 that is stored and held in the storage body member 30 is released from the holding state, the item M1 easily slides along the bottom wall portion 32 toward the vehicular interior side. Therefore, it is not necessary to insert a hand into the storage body member 30 through the trim side opening 16 to take the item M1 from the storage body member 30 and this enhances convenience for users. It is not necessary to insert a hand into the storage body member 30 through the trim side opening 16. Therefore, the size of the trim side opening 16 can be set to be smallest such that the item M1 can pass through.

The vehicular interior side end portion 32A of the bottom wall portion 32 is disposed lower than the lower hole edge 16A of the trim side opening 16 of the deck side trim 12R. Furthermore, friction is caused between the bottom wall portion 32 of the storage body member 30 and the item M1 when the item M1 moves. With such a configuration, the item M1 that slides along the bottom wall portion 32 or moves towards the trim side opening 16 stops at the lower hole edge 16A of the trim side opening 16 as illustrated in FIG. 5. The item M1 is tilted frontward and the upper portion of the item M1 is outside the storage portion 20R through the trim side opening 16. Therefore, the item M1 is less likely to jump out through the trim side opening 16 completely and drop from the storage portion 20R into the luggage compartment 10. To take the item M1 from the storage body member 30, a user can hold the upper portion of the item M1 that is outside the storage portion 20R through the trim side opening 16 and can easily take the item M1 from the storage portion 20R.

The fastener band 50 is a hook and loop fastener and includes the hook portion on at least one surface of one end portion thereof and the loop portion on the one surface of a portion other than the hook portion. The hook portion and the loop portion can be attached to each other. The square ring 51 for folding the fastener band is attached to other end portion of the fastener band 50. With such a configuration, the item M1 can be held easily with respect to the storage body member 30 and can be released easily from the holding state.

With the stud bolts 19, which are mounted in the inner panel 18, being fitted into the gromets 40 that are mounted in the through holes 36 of the storage body member 30 and the fastener side through holes 52 of the fastener band 50, the storage body member 30 and the fastener band 50 are fixed to the inner panel 18.

The gromet 40 includes the first member 41 and the second member 45. The first member 41 includes the outer tubular portion 42 that has a tubular shape and can be fitted in the through holes 36, 52 and the first flange portion 44 that extends outwardly from one end portion of the outer tubular portion 42 (one end portion of the gromet 40) in a radial direction of the outer tubular portion 42. The second member 45 includes the inner tubular portion 46 that is fitted in the outer tubular portion 42 and in which the stud bolt 19 can be fitted and the second flange portion 47 that extends outwardly from other end portion of the inner tubular portion 46 (other end portion of the gromet 40 opposite from the one end portion) in a radial direction of the inner tubular portion 46. With such a configuration, the gromet 40 can be surely mounted in the storage body member 30 and the fastener band 50.

### Other Embodiments

The technology described herein is not limited to the embodiments described above with reference to the drawings. The following embodiments may be included in the technical scope. The technology described herein may be modified within the technical scope.
(1) In the above embodiment, the storage portions 20R, 20L are mounted in the rear surface of the luggage compartment 10 but may be mounted in a side surface of the luggage compartment. The storage portions may be mounted in any other portion of the vehicular compartment other than the luggage compartment.
(2) In the above embodiment, the storage body member 30 is a molded body made of expanded beads. However, the storage body member may be made of other material.
(3) In the above embodiment, the bottom wall portion 32 of the storage body member 30 slopes downward as it extends toward the vehicular interior side. The bottom wall portion may horizontally extend. The vehicular interior side end portion 32A of the bottom wall portion 32 may be disposed upper than the lower hole edge 16A of the trim side opening 16 and the lower hole edge 22A of the frame side opening 22.
(4) The belt member may not be the fastener band 50 but may be other component.
(5) The storage portion and the belt member may not be necessarily fixed to the vehicular body with the gromets and the stud bolts but may be fixed with bolts and nuts (a fastening structure).

1. A vehicular storage structure comprising:
a storage body member that stores an item and is accessible through an opening of a vehicular interior component from a vehicular interior side and disposed on a vehicular exterior side of the opening; and
a belt member having an elongated shape and elasticity and being configured to hold the item stored in the storage body member with respect to the storage body member, the belt member being fixed to a vehicular body together with the storage body member.

2. The vehicular storage structure according to claim 1, wherein the storage body member is a molded member made of expanded beads.

3. The vehicular storage structure according to claim 1, wherein
the storage body member has a receiving surface where the item is disposed, and
the receiving surface is inclined downward as it extends toward the vehicular interior side.

4. The vehicular storage structure according to claim 3, wherein the receiving surface has a vehicular interior side end portion that is disposed lower than a lower hole edge of the opening of the vehicular interior component.

5. The vehicular storage structure according to claim 1, wherein the belt member is a fastener band that includes
a hook portion on one surface of one end portion of the fastener band, and
a loop portion on the one surface of a portion of the fastener band other than the one end portion, the loop portion being attached to the hook portion, and
a ring for folding the fastener band is at other end of the fastener band.

6. The vehicular storage structure according to claim 1, wherein
the storage body member includes a first through hole,
the belt member includes a second through hole,
a gromet is mounted in the first through hole and the second through hole, and
the storage body member and the belt member are fixed to the vehicular body with a stud bolt mounted in the vehicular body being fitted in the gromet.

7. The vehicular storage structure according to claim 1, wherein the gromet includes
a first member that includes an outer tubular portion that is fitted in the first through hole and the second through hole and a first flange portion that extends outwardly in a radial direction from one end portion of the outer tubular portion, and
a second member that includes an inner tubular portion that is fitted in the outer tubular portion and a second flange portion that extends outwardly in a radial direction from an end portion of the inner tubular portion that is on an opposite side from the one end portion.

8. The vehicular storage structure according to claim 1, wherein the storage body member includes
a rear wall portion extending along the vehicular body and having a vehicular exterior side surface that faces the vehicular body and including a projection that projects from the vehicular exterior side surface, and
a bottom wall portion extending from the rear wall portion toward the opening and on which the item is disposed.

9. The vehicular storage structure according to claim 1, wherein the storage body member includes
a rear wall portion extending along the vehicular body and having a vehicular exterior side surface that faces the vehicular body and a vehicular interior side surface that faces the opening of the vehicular interior component and slopes closer to the opening of the vehicular interior component as it extends upward, and
a bottom wall portion that slopes downward as it extends from the vehicular interior side surface toward the opening of the vehicular interior component and on which the item is disposed.

10. The vehicular storage structure according to claim 1, wherein
the storage body member includes a rear wall portion extending along the vehicular body and includes a first through hole in the rear wall portion,
the belt member includes a second through hole, and
a fixing member is inserted through the first through hole, the second through hole, and a through hole in the vehicular body and thus the storage body member and the belt member are fixed to the vehicular body.

11. The vehicular storage structure according to claim 10, wherein
the rear wall portion includes a recessed portion that is recessed toward the vehicular exterior side, and
the recessed portion includes the first through hole.

12. The vehicular storage structure according to claim 11, wherein
the vehicular exterior side surface of the rear wall portion and a recessed surface of the recessed portion extend parallel to each other.

13. The vehicular storage structure according to claim 9, wherein the bottom wall portion has a vehicular interior side end portion that is disposed lower than a lower hole edge of the opening of the vehicular interior component.
